(19) United States
(12) Patent Application Publication
(10) Pub. No.: US 2010/0205538 A1
(43) Pub. Date: Aug. 12, 2010

(54) METHOD OF PROVIDING A USER INTERFACE FOR A MOBILE TERMINAL

(75) Inventors: Ji Young HAN, Seoul (KR); Jang Hyeon JO, Gyeonggi-do (KR)

Correspondence Address: CHA & REITER, LLC, 210 ROUTE 4 EAST STE 103, PARAMUS, NJ, 07652, US

(73) Assignee: Samsung Electronics Co., LTD., Gyeonggi-Do (KR)

(21) Appl. No.: 12/701,942

(22) Filed: Feb. 8, 2010

(30) Foreign Application Priority Data
Feb. 11, 2009 (KR) 10-2009-0011113

(51) Int. Cl. G06F 3/048; G06F 15/16

(52) U.S. Cl. 715/752; 715/810; 709/206

(57) ABSTRACT

A method of providing a user interface of a mobile terminal is provided. The method of providing a user interface of a mobile terminal having an instant messenger service capability includes: activating the instant messenger; and outputting a user interface screen including a selection window to which a preset selection menu is linked in order to change an entire or a part of a screen.

### CLAIM OF PRIORITY

This application claims, pursuant to 35 USC 119, priority to, and the benefit of the earlier filing date of, Korean Patent Application No. 10-2009-0011113 filed in the Korean Intellectual Property Office on Feb. 11, 2009, the entire contents of which are incorporated herein by reference.

### BACKGROUND OF THE INVENTION

1. Field of the Invention

The present invention relates to the field of mobile terminal interfaces and more particularly, to a method of providing a user interface for a mobile terminal that can improve user convenience when using an instant messenger.

2. Description of the Related Art

Nowadays, mobile terminals that are very widely used provide various data transmission services and various additional services as well as an intrinsic voice communication service due to technology development. For example, the mobile terminal may provide a digital broadcasting service, wireless Internet service, and/or a character message service. Further, the mobile terminal can use an instant messenger (hereinafter, IM) service typically found only in a personal computer (PC). The mobile terminal can use a plurality of IMs. That is, a user of the mobile terminal can simultaneously use a plurality of IM services.

However, due to restrictions in size of a display unit and performance of the mobile terminal, the mobile terminal does not provide a user interface (hereinafter, an UI) of the same IM as that of a general PC. Thereby, an UI of a conventional IM of the mobile terminal may be inconvenient to a user familiar with an UI found in a general PC environment. For example, in an UI of a conventional IM, when a new conversation message is received while performing communication with a another party, in order to check the new conversation message, a user selects the other party having transmitted the conversation message after returning to a screen that can select the other party. That is, in an UI of a conventional IM, in order to check a conversation message, a plurality of steps must to be performed. However, in a mobile phone, due to size restrictions of the screen, it is difficult to check another party's information (for example, identification (ID) or a nickname of another party). Further, when the mobile terminal provides a plurality of IM services, in order to change to another IM while viewing a specific IM, the user must select another IM after returning to an IM selection screen. That is, in an UI of a conventional mobile terminal IM, in order to change the IM to another IM, a plurality of steps must be performed.

### SUMMARY OF THE INVENTION

The present invention provides a method of providing an UI of a mobile terminal that can improve user convenience particularly in accessing and viewing instant messages.

In accordance with an aspect of the present invention, a method of providing an UI of a mobile terminal having an instant messenger feature or service includes: activating the instant messenger; and outputting an UI screen including a selection window to which a preset selection menu is linked in order to change at least one of: an entire and a part of a screen. In accordance with another aspect of the present invention, an UI of a mobile terminal for providing an instant messenger service includes: an information display area for displaying information necessary for using the instant messenger; and a selection window display area for displaying a selection window to which a preset selection menu is linked in order to change at least one of: an entire and a part of a screen.

In accordance with another aspect of the present invention, an apparatus providing a user interface of a mobile terminal having an instant messenger service includes: a processor in communication with a memory, the memory including code, which when accessed by the processor causes the processor to: activate the instant messenger service; and output a user interface screen including a selection window to which a preset selection menu is linked in order to change at least one of: an entire and a part of a screen.

### BRIEF DESCRIPTION OF THE DRAWINGS

The above features and advantages of the present invention will be more apparent from the following detailed description in conjunction with the accompanying drawings, in which:

FIGS. 1a to 1d illustrate examples of a screen illustrating a method of providing an UI of a mobile terminal according to an exemplary embodiment of the present invention;

FIGS. 2a to 2c illustrate examples of a screen illustrating a method of providing an UI of a mobile terminal according to instant messenger selections;

FIGS. 3a to FIG. 3c illustrate examples of a screen illustrating a method of providing an UI of a mobile terminal according to group selection;

FIGS. 4a to 4f illustrate examples of a screen illustrating a method of providing an UI of a mobile terminal according to another party selection;

FIG. 5 illustrates an example of a screen illustrating a method of providing an UI of a mobile terminal according to another exemplary embodiment of the present invention;

FIG. 6 is a flowchart illustrating a method of providing an UI of a mobile terminal according to another exemplary embodiment of the present invention; and

FIG. 7 is a block diagram illustrating a configuration of a mobile terminal according to another exemplary embodiment of the present invention.

### DETAILED DESCRIPTION OF THE INVENTION

Exemplary embodiments of the present invention are described in detail with reference to the accompanying drawings. The same reference numbers are used throughout the drawings to refer to the same or like parts. The views in the drawings are schematic views only, and are not intended to be to scale or correctly proportioned. For the purposes of clarity and simplicity, detailed descriptions of well-known functions and structures incorporated herein may be omitted to avoid obscuring the subject matter of the present invention.

While the present invention may be embodied in many different forms, specific embodiments of the present invention are shown in drawings and are described herein in detail, with the understanding that the present disclosure is to be considered as an exemplification of the principles of the invention and is not intended to limit the invention to the specific embodiments illustrated.

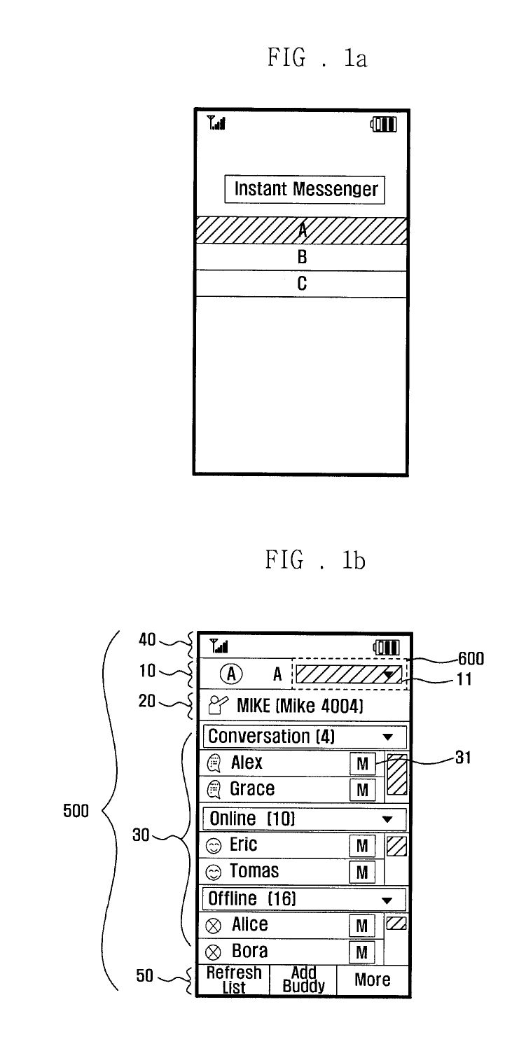

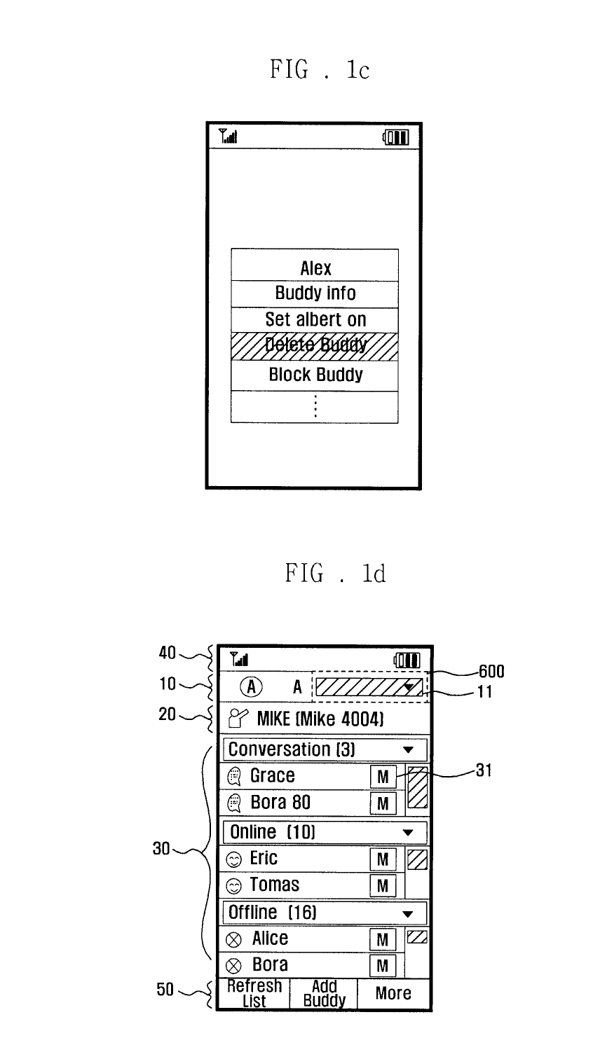

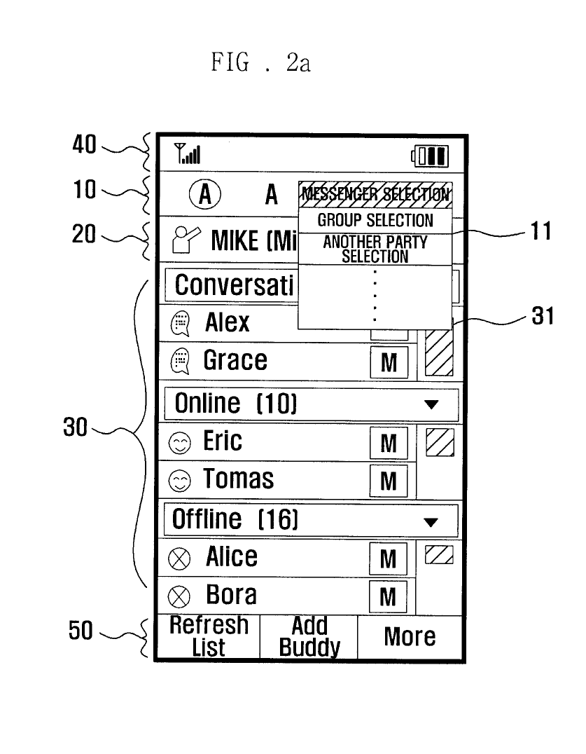

FIGS. 1a to 1d illustrate examples of a screen illustrating a method of providing an UI of a mobile terminal according to an exemplary embodiment of the present invention.

Referring to FIGS. 1a to 1d, when an instant messenger (hereinafter, IM) service is executed, the mobile terminal outputs a screen for displaying available IMs. For example, when the IM service is executed, the mobile terminal may display a plurality of IMs “A”, “B”, and “C”, as shown in FIG. 1a. When the user selects the IM “A” from among the illustrated plurality of IMs, the mobile terminal displays a list screen corresponding to the selected IM “A”, as shown in FIG. 1b. The list screen according to the present exemplary embodiment is formed with an information display area 500 and a selection window display area 600.

The information display area 500 is an area for displaying information necessary for viewing the IM “A” selected by the user and includes an indicator area 40, IM logo display area 10, user information display area 20, another party information display area 30, and menu display area 50.

The indicator area 40 is an area for displaying an icon providing information such as a reception state of the mobile terminal, battery residual quantity, and alarm setting. Although not shown in FIG. 1b, when a conversation message is received from an IM server, the indicator area 40 may also display an image (for example, a speech balloon icon) notifying reception of the conversation message.

The IM logo display area 10 is an area for displaying a logo of an IM in order to alert the user of a kind of a presently activated IM. The logo of the IM is displayed with at least one of an image or a text.

The user information display area 20 is an area for displaying information about a user using the IM and is displayed with at least one of identification (hereinafter, ID) or a nickname of the user. In the present exemplary embodiment, for convenience of description, the user's ID is displayed.

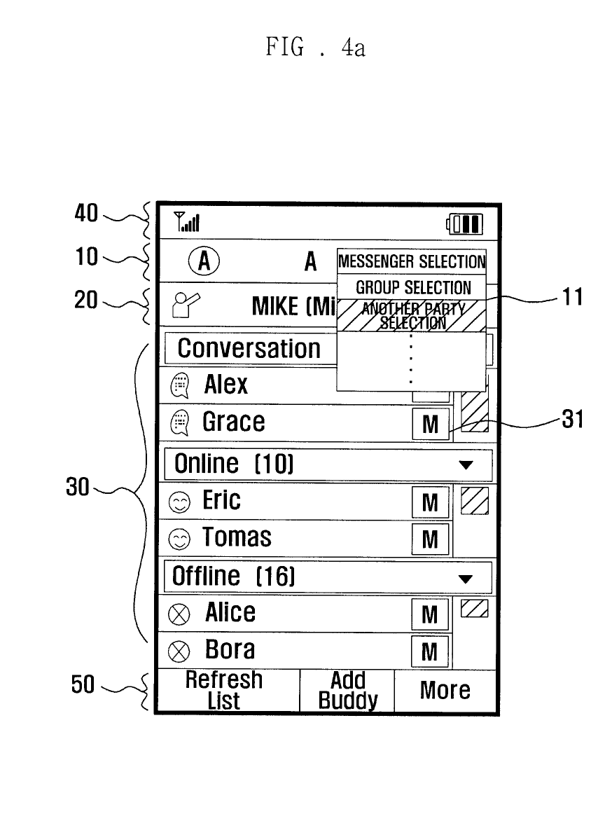

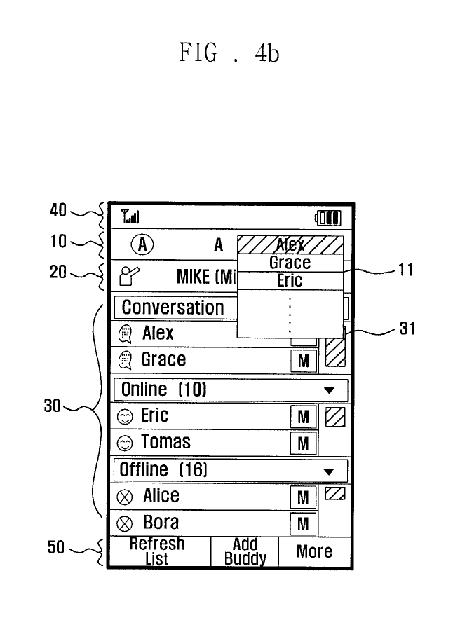

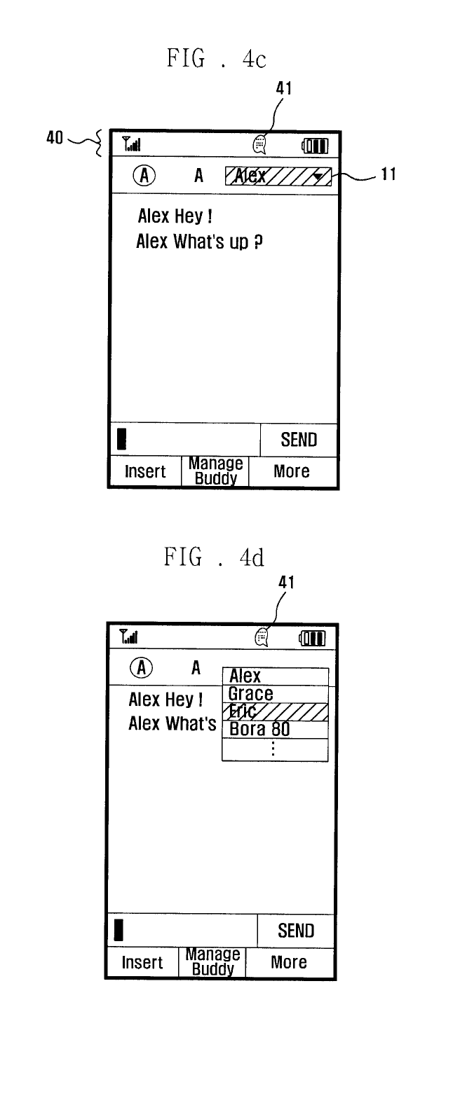

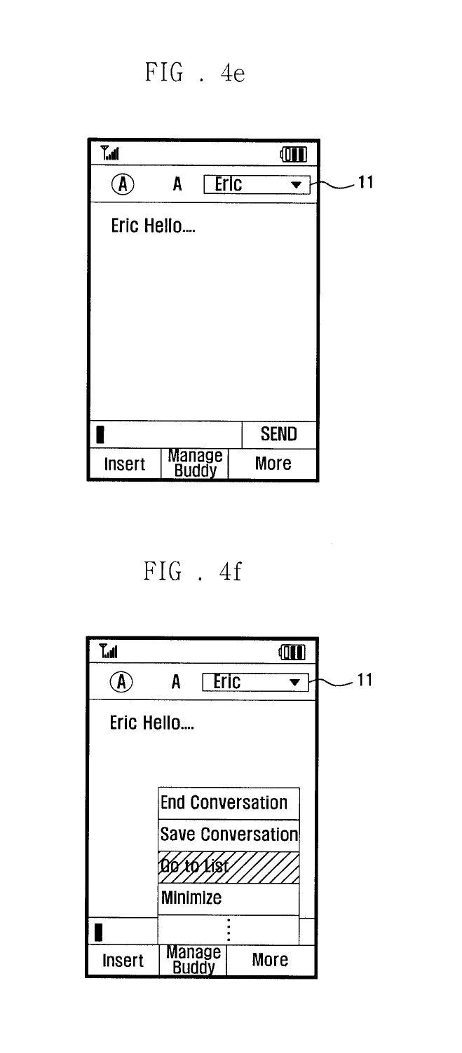

The other party information display area 30 is an area for displaying information of another party registered by the user in the IM. The other party's information is displayed with at least one of ID and a nickname of the other party. In the present exemplary embodiment, for convenience of description, the ID of other parties is displayed. In this case, IDs of the other parties are classified and displayed on a preset group basis. For example, as shown in FIG. 1b, IDs of other parties are classified into a conversation group, online group, and offline group and are displayed. When an ID of another party is selected by the user, the mobile terminal outputs a conversation window for transmitting and receiving a conversation message with the selected party. A detailed description regarding the conversation window is described with reference to FIGS. 4a to 4f. Further, the mobile terminal displays a management menu icon 31 for activating a management menu of other parties at one side of an area of the other party information display area 30. That is, when the management menu icon 31 is activated by the user, for example a touch, the mobile terminal displays the management menu in a pop-up window form. The management menu includes “Buddy Info” for requesting profile information about the selected party, “Delete Buddy” for deleting the selected party from a list, and “Block Buddy” for rejecting reception of a conversation message of the selected party and displays a presently selected user ID. For example, as shown in FIG. 1c, another party's ID “Alex” is displayed at the upper end and the management menu is displayed at a lower part. In this case, when a “Delete Buddy” menu is selected by the user (as shown using hashing the selected item), the mobile terminal deletes the selected party's ID from a list screen. That is, the mobile terminal deletes “Alex” from a conversation group of the list screen and displays “Bora80,” which has previously not been displayed, (see FIG. 1d). Further, the mobile terminal changes the number of parties belonging to the conversation group from “4” to “3”.

The management menu can be changed according to an on-line state or an off-line state of the selected parties. For example, a management menu of other parties in an on-line state may include a “conversation” menu, while a management menu of another party in an off-line state may not include a “conversation” menu. And when a management menu of information of another party in which reception of a message is rejected is activated, a “Block Buddy” menu may be changed to an “Unblock Buddy” menu for releasing rejection of message reception and the “Unblock Buddy” menu is displayed (see FIG. 1c).

The menu display area 50 (FIG. 1b) is an area of displaying an executable menu on the list screen. For example, the menu display area 50 may include a “Refresh List” menu for requesting to update a screen, an “Add Buddy” menu for adding a friend, and a “More” menu for including other menus, as shown in FIG. 1b. For example, another party may be added to the IM by the user using the “Add Buddy” menu included in the menu display area 50, and the screen of the mobile terminal may be returned to the screen of FIG. 1a that can select an IM using the “More” menu.

The selection window display area 600 is an area for displaying a selection window to which a preset selection menu is linked in order to change an entire or a part of a screen. The selection menu may include at least one of a messenger selection menu, group selection menu, and another party selection menu. That is, in the present exemplary embodiment, the list screen can be changed to a list screen of another messenger without returning to a messenger selection screen shown in FIG. 1a using a messenger selection menu linked to the selection window 11. That is a group name displayed on the list screen can be selected using the group selection menu, and a conversation window for having a conversation with another party that is not displayed on the screen due to restriction in screen size of the mobile terminal can be easily selected using the another party selection menu, thereby improving user convenience. A detailed description of a method of providing an UI of a mobile terminal according to messenger selection, another party selection, and group selection using the selection window 11 is described later.

FIG. 1a illustrates that the mobile terminal provides three kinds of IM services, however the present invention is not limited thereto. That is, the mobile terminal includes at least one IM. In this case, when the mobile terminal provides only one IM, if the IM service is executed, the mobile terminal does not display a screen of FIG. 1a but displays a list screen or a connection screen (log-in screen).

An exemplary embodiment of the present invention is described in detail hereinafter.

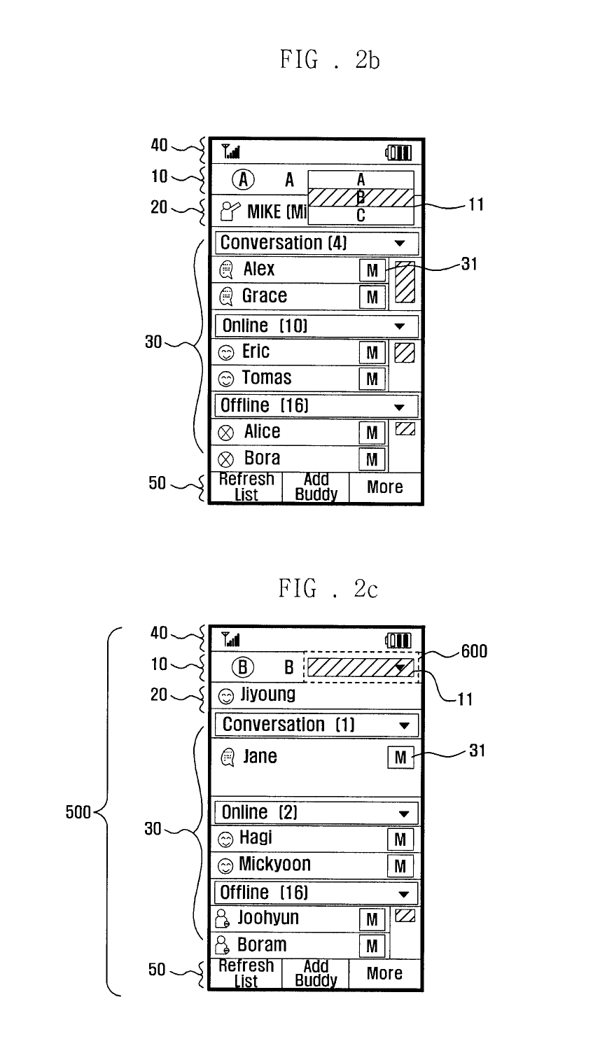

FIGS. 2a to 2c illustrate examples of a screen illustrating a method of providing an UI of a mobile terminal according to messenger selection using a selection window.

Referring to FIGS. 2a to 2c, when the selection window 11 on the list screen is activated by the user, the selection window 11 outputs a preset selection menu such as messenger selection, group selection, and another party selection, as shown in FIG. 2a. In this case, when a messenger selection menu is activated by the user, the selection window 11 outputs indexes “A”, “B”, and “C” corresponding to a plurality of IMs provided by the mobile terminal using a drop-down method, as shown in FIG. 2b. Thereafter, when an IM “B” is selected (as shown using hashing the selected item), the mobile terminal displays a list screen of the IM “B”, as shown in FIG. 2c. As described above, the list screen of the IM “B” includes an information display area 500 and a selection window display area 600. In this case, when comparing FIG. 2a and FIG. 2c, a logo of the IM is changed from “A” to “B” and the user ID is changed from “MIKE” (20, FIG. 2b) to “Jiyoung” (20, FIG. 2c), and IDs of the other parties are changed to “Jane”, “Hagi”, “Mickyoon”, “Joohyun”, and “Boram”. (FIG. 2c). This is because IDs for each IM can be differently set by the user, and registered other parties can be changed.

A method of providing an UI of a mobile terminal according to group selection using the selection window 11 is described hereinafter.

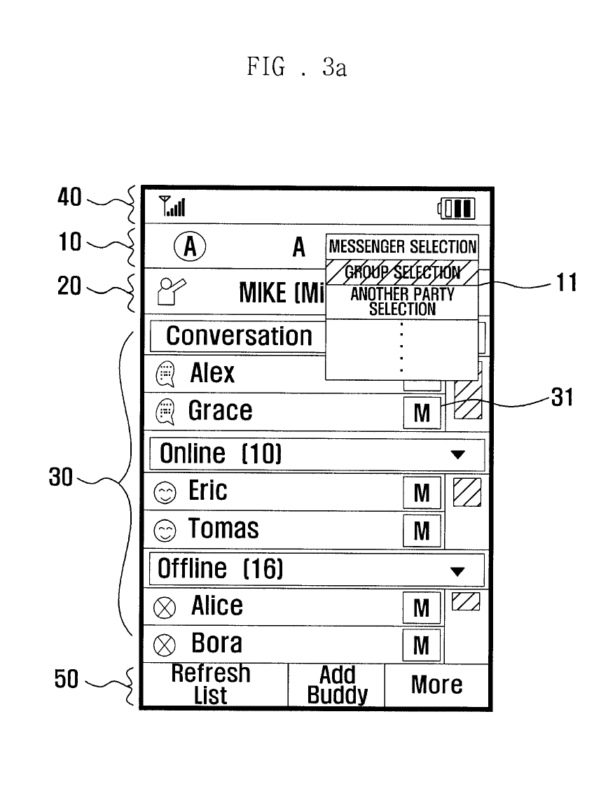

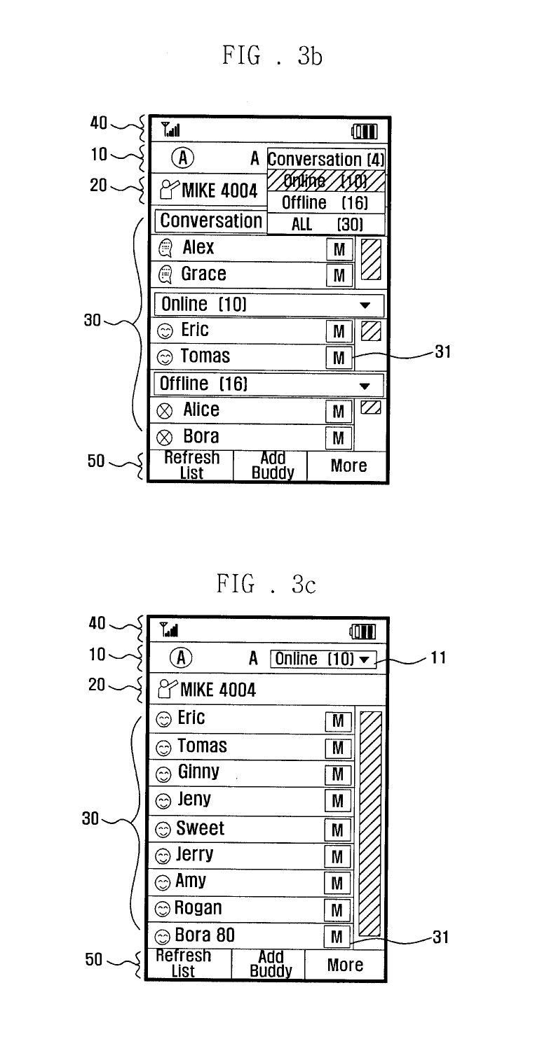

FIGS. 3a to FIG. 3c illustrate examples of a screen illustrating a method of providing an UI of a mobile terminal according to group selection using the selection window 11.

Referring to FIGS. 3a to 3c, when the selection window 11 on a list screen is activated by the user, the selection window 11 outputs a preset selection menu such as messenger selection, group selection, and another party selection, as shown in FIG. 3a. In this case, when a group selection menu is activated by the user (as indicated by hashing the selected item), the selection window 11 displays a plurality of groups (for example, conversation, online, and offline) names, as shown in FIG. 3b. Thereafter, when a specific group name of a plurality of group names is selected, the mobile terminal displays only a group name selected from the other party information display area 30 and information of another party belonging to the group. As shown in FIG. 3c, when the selected group is ‘online’, the mobile terminal displays an online group name and IDs, “Eric”, “Tomas”, “Ginny”, “Jeny”, “Sweet”, “Jerry”, “Amy”, “Rogan”, and “Bora 80” (30, FIG. 3c) belonging to the online group. That is, even if a plurality of groups are registered, in the present exemplary embodiment, because only a group name selected by the user and information of other parties belonging to the selected group are displayed in the other party information display area 30. Thus, a larger number of parties information, can be displayed as compared to a conventional display.

A method of providing an UI of a mobile terminal according to another party selection using the selection window 11 is described hereinafter.

FIGS. 4a to 4f illustrate examples of a screen illustrating a method of providing an UI of a mobile terminal according to another party selection using the selection window 11.

Referring to FIGS. 4a to 4f, when the selection window 11 on the list screen is activated by the user, the selection window 11 outputs a preset selection menu such as messenger selection, group selection, and another party selection, as shown in FIG. 4a. When another party selection menu is activated (as indicated by hashing the selected item) by the user, the selection window 11 arranges IDs of other parties that can presently have a conversation, as shown in FIG. 4b. Thereafter, when a specific other party is selected by the user, the mobile terminal displays a first conversation window that can transmit and receive a message with a specific other party (for example, “Alex”), as shown in FIG. 4c. Alternatively, the mobile terminal may display the first conversation window by selecting another party's ID on the list screen, as described in relation to FIG. 1b. In this case, the first conversation window may also include the selection window 11 at one side thereof.

When a new conversation message is received from another party, the mobile terminal displays an image 41 (for example, a speech balloon icon) notifying reception of a new conversation message in the indicator area 40, as shown in FIG. 4c. As described above, when the selection window 11 and another party selection menu are activated by the user, the mobile terminal displays IDs of other parties belonging to a conversation group. For example, when the selection window 11 is activated, the mobile terminal displays IDs “Alex”, “Grace”, “Eric”, and “Bora80” belonging to a conversation group, as shown in the FIG. 4d. In this case, the mobile terminal can display IDs of parties having transmitted a message that is not checked by the user. For example, the mobile terminal can display a character in a different manner (e.g., flicker a color, a lightness, and a character size) of the party having transmitted the message.

The mobile terminal updates the ID of the other party belonging to a conversation group in real time. That is, when the other party who does not belong to a conversation group requests to have a conversation, the mobile terminal adds the ID of the party having requested to have a conversation to the conversation group. Thereafter, when ID of another party (for example “Eric”), having transmitted a message is selected (as indicated by hashing the selected item), the mobile terminal outputs a second conversation window for transmitting and receiving a conversation message with the selected other party, as shown in FIG. 4e. Referring to FIG. 4e, the speech balloon icon 41 displayed in the indicator area 40 (as shown in FIG. 4d) disappears and ID of another party is changed to “Eric”, and a message “Hello” transmitted by “Eric” is output.

Further, as shown in FIG. 4f, when a “More” menu displayed at the right lower end of the second conversation window is activated by the user, if a “Go to List” menu of the displayed menu is selected by the user (as indicated by hashing the selected item), the screen of the mobile terminal returns to the list screen.

In the foregoing description, when the other party selection menu is activated using the selection window 11, the mobile terminal displays ID of parties belonging to a conversation group. However the present invention is not limited thereto. That is, when the other party selection menu is activated using the selection window 11, the mobile terminal may further display IDs of another party belonging to an online group. This is because when the user tries to transmit a message to another party belonging to an online group while having a conversation with a different party, a conversation window for transmitting a message to the other party belonging to the online group can be output using the selection window 11 without returning to the list screen.

Further, in the foregoing description, when the selection window 11 is activated, all of a messenger selection menu, another party selection menu, and group selection menu are activated. However, the present invention is not limited to such a configuration and it would be recognized that other selection menus may be implemented without altering the scope of the invention. For example, when other parties are not within the conversation group, for example, when the selection window 11 is activated, the mobile terminal may not display the other party selection menu, or may display the inactivated selection window 11 so that the user cannot select another party.

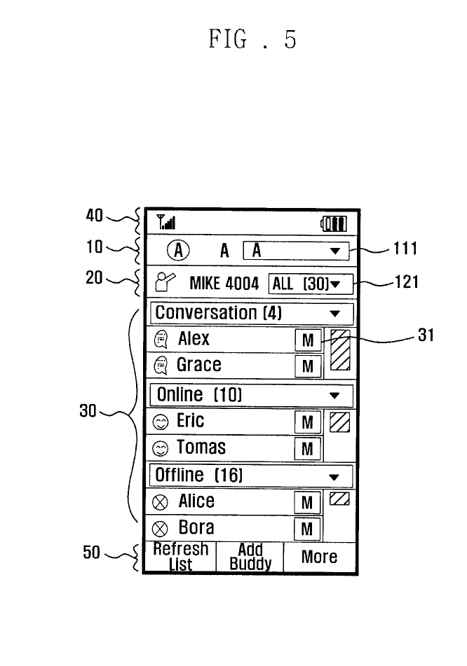

Further, in the foregoing description, the messenger selection menu, another party selection menu, and group selection menu are linked to the selection window 11. However, the present invention is not limited such a configuration. That is, in the present invention, the messenger selection menu, group selection menu, and other party selection menu can be classified and displayed in a plurality of areas. For example, as shown in FIG. 5, the mobile terminal may display a messenger selection window 111 that can select an IM and a group selection window 121 that can select a group name. In this case, the mobile terminal displays the messenger selection window 111 in the IM logo display area 10 and the group selection window 121 in the user information display area 20. In this case, a step of activating the selection window 11 for selecting a messenger or a group may be omitted and thus user convenience is further improved. Further, the mobile terminal can display other party selection window that can select another party at one side of the conversation window.

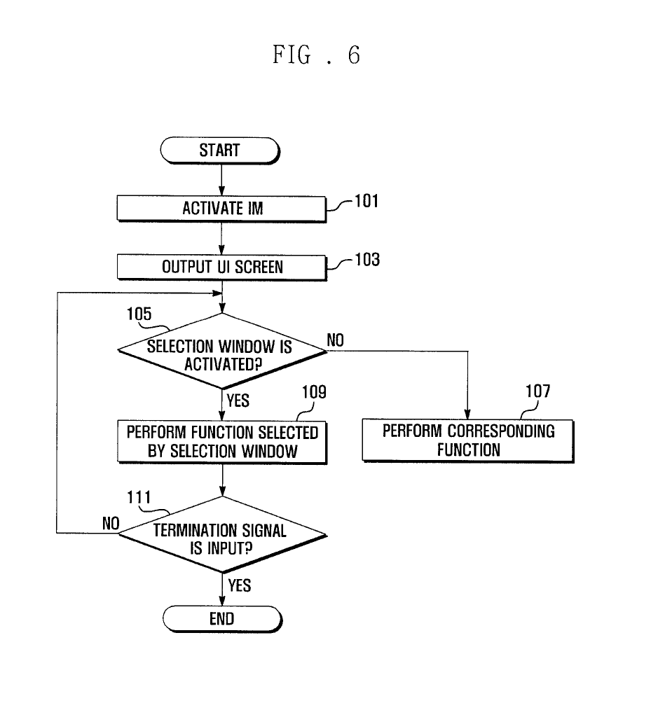

FIG. 6 is a flowchart illustrating a method of providing an UI of a mobile terminal according to another exemplary embodiment of the present invention.

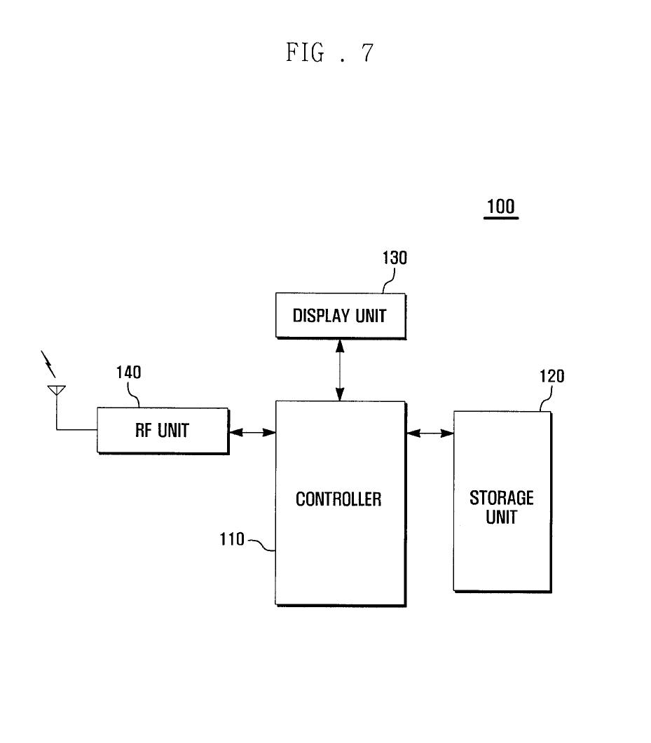

Referring to FIG. 6, the controller 110 controls to activate an IM (101). The controller 110 (see FIG. 7) controls to output an UI screen (for example, a list screen) of the IM (103). In this case, the UI screen includes the selection window 11 as previously described.

The controller 110 determines whether the selection window 11 is activated (105). If the selection window 11 is not activated, the controller 110 controls the execution of a corresponding function (107). For example, the controller 110 may control the execution of a function, such as friend addition and friend deletion according to user selection. If the selection window 11 is activated, the controller 110 controls the execution of a function selected by a selection window 11 (109). For example, if a function selected by the selection window 11 is a messenger selection, the screen of the mobile terminal is converted to an interface screen of an IM selected by the user. Alternatively, if a function selected by the selection window 11 is a group selection, the mobile terminal displays only a group name selected by the user and information of another party belonging to the group on a list screen of the IM.

The controller 110 determines whether a termination signal is input (111). If a termination signal is not input, the process returns to step 105. Otherwise, if a termination signal is input, the controller 110 terminates the IM.

A configuration of a mobile terminal according to another exemplary embodiment of the present invention is described hereinafter.

FIG. 7 is a block diagram illustrating a configuration of a mobile terminal 100 according to another exemplary embodiment of the present invention.

Referring to FIG. 7, the mobile terminal 100 includes a controller 110, storage unit 120, display unit 130, and radio frequency (RF) unit 140.

The RF unit 140 forms a communication channel with a base station in order to perform data communication and voice communication, and performs voice communication with another mobile terminal, or transmits and receives data to and from another mobile terminal using the communication channel. For this, the RF unit 140 includes an RF transmitter for up-converting a frequency of a signal to be transmitted and amplifying the signal, and an RF receiver for low-noise amplifying a received signal and down-converting a frequency of the signal. Particularly, in the present exemplary embodiment, the RF unit 140 transmits and receives data to and from an IM server through an information communication network (for example, the internet) under the control of the controller 110. When the mobile terminal 100 has a plurality of IMs, the RF unit 140 transmits and receives data to and from each of a plurality of IM servers.

The storage unit 120 stores a program for controlling general operations of the mobile terminal 100, an operating system for booting the mobile terminal 100, and an application program necessary for reproducing multimedia contents. Further, the storage unit 120 stores data generated according to use of the mobile terminal 100. Particularly, in the present exemplary embodiment, the storage unit 120 stores a plurality of application programs for providing a plurality of IM services. The storage unit 120 stores an UI of the IM. Further, the storage unit 120 stores a preset group name and information and icon of another party belonging to each group.

The display unit 130 displays various menu screens of the mobile terminal 100, user data input by a user function setting information, or various information provided to the user. The display unit 130 is formed with one of a liquid crystal display (LCD) and an organic light-emitting diode (OLED). Further, when the display unit 130 is formed as a touch screen, the display unit 130 can be operated as an input means. Particularly, in the present exemplary embodiment, the display unit 130 displays an UI screen for providing an IM service by the control of the controller 110. For example, the display unit 130 may display the UI screen shown in FIGS. 1a to 1d, 2a to 2c, 3a to 3c, 4a to 4fF, and 5 as an example of an UI screen.

The controller 110 controls general operations of the mobile terminal 100 and a signal flow between units of the mobile terminal 100 and controls a data processing function. When the IM is activated by the user, the controller 110 controls to display an UI screen (for example, a list screen) for providing an IM service. Particularly, in the present exemplary embodiment, when a messenger selection menu is activated using a selection window included in the list screen, the controller 110 controls the display of IMs provided in the mobile terminal, and when a specific IM is selected by the user, the controller 110 controls the display of an UI screen corresponding to the selected IM. In this case, when the user does not log in, the controller 110 controls the display of a log-in screen of the selected IM.

Further, when a group selection menu is activated, the controller 110 controls the display of group names registered in an IM connected by the user, and when the user selects a specific group, the controller 110 controls the display of only a group name selected by the user and information of another party belonging to the selected group in the other party information display area.

Further, when a new message is received from another party, the controller 110 controls the display of an image (for example, a speech balloon icon) notifying the user of the reception of a new message in an indicator area. In this case, the controller 110 may flicker the image so that the user may easily recognize the image.

When the other party selection menu is activated, the controller 110 controls the display of information of another party belonging to a conversation group. In this case, the controller 110 controls the display to display differences in a color, a size, and/or a contrast of ID of other parties having transmitted the new message so that the user may easily distinguish the party having transmitted the message. Alternatively, the controller 110 may flicker the ID of other parties having transmitted the new message. Thereafter, when one of the other party's information is selected, the controller 110 controls the output of a conversation window for having a conversation with the selected another party. In the foregoing description, when the other party selection menu is activated, the controller 110 controls the display of IDs of parties belonging to a conversation group. However the present invention is not limited thereto. That is, when the other party selection menu is activated, the controller 110 controls the display of IDs of parties belonging to an online group.

Although not shown, the mobile terminal 100 may further include constituent elements having an additional function, such as a camera module for photographing an image or a moving picture, broadcasting reception module for broadcasting reception, audio signal output device such as a speaker, audio signal input device such as a microphone, and digital sound source reproduction module such as an MP3 module.

As described above, a method of providing an UI of a mobile terminal according to the present invention, a screen of the mobile terminal can be easily changed using a selection window, thereby improving user convenience. Further, by displaying only a selected specific group on an UI screen, information regarding other parties may be displayed.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. As would be recognized by those skilled in the art, when a general purpose computer is loaded with, or accesses, software or code for implementing the processing shown herein, the general purpose computer is transformed into a special purpose computer that may at least perform the processing shown herein.

Although exemplary embodiments of the present invention have been described in detail hereinabove, it should be clearly understood that many variations and modifications of the basic inventive concepts herein described, which may appear to those skilled in the art, will still fall within the spirit and scope of the exemplary embodiments of the present invention as defined in the appended claims.

What is claimed is:

1. A method of providing a user interface of a mobile terminal having an instant messenger, comprising:
activating the instant messenger; and
outputting a user interface screen including a selection window to which a preset selection menu is linked in order to change at least one of: an entire and a part of a screen.

2. The method of claim 1, wherein the selection menu comprises at least one of a messenger selection menu, group selection menu, and another party selection menu.

3. The method of claim 2, further comprising:
activating the another party selection menu using the selection window;
displaying information of other parties registered in the instant messenger;
selecting one of the displayed information of other parties; and
outputting a conversation window for having a conversation with the selected another party.

4. The method of claim 3, wherein displaying information of other parties registered in the instant messenger comprises visually distinguishably displaying information of at least one another party having transmitted a conversation message and information of the others.

5. The method of claim 4, wherein displaying information of other parties registered in the instant messenger further comprises displaying information of at least one another party while being connected to the instant messenger.

6. The method of claim 2, further comprising:
activating a group selection menu using the selection window;
outputting, when the group selection menu is activated, a plurality of group names registered in the instant messenger;
selecting a specific group name from the plurality of group names; and
outputting the selected specific group name and information of parties included in the specific group.

7. The method of claim 2, further comprising:
activating the messenger selection menu using the selection window;
outputting, when the messenger selection menu is activated, indexes corresponding to a plurality of instant messengers provided by the mobile terminal;
selecting one of the plurality of indexes; and
outputting a user interface screen of an instant messenger corresponding to the selected index.

8. A user interface of a mobile terminal for providing an instant messenger service, comprising:
an information display area for displaying information necessary for using the instant messenger; and
a selection window display area for displaying a selection window to which a preset selection menu is linked in order to change at least one of: an entire and a part of the screen.

9. The user interface of claim of 8, wherein the selection window display area displays information of at least one another party having transmitting a conversation message using a drop down method.

10. The user interface of claim of 9, wherein the selection window display area visually distinguishably displays information of the at least one another party having transmitted the conversation message and information of the others.

11. The user interface of claim of 8, wherein the selection window display area displays group names registered in the instant messenger using a drop down method.

12. The user interface of claim of 8, wherein the selection window display area displays an index of instant messengers provided by the mobile terminal using a drop down method.

13. The user interface of claim of 12, wherein the selection window display area comprises:
a messenger selection window area for converting to a user interface screen of another instant messenger; and
a group selection window area for selecting a specific group among displayed groups in the information display area.

14. An apparatus providing a user interface of a mobile terminal having an instant messenger service, the apparatus, comprising:
a processor in communication with a memory, the memory including code, which when accessed by the processor causes the processor to:
activate the instant messenger service; and
output a user interface screen including a selection window to which a preset selection menu is linked in order to change at least one of: an entire and a part of, a screen.

15. The apparatus of claim 14, wherein the selection menu comprises at least one of a messenger selection menu, group selection menu, and another party selection menu.

16. The apparatus of claim 15, wherein the processor is further configured to:
activate the another party selection menu using the selection window;
display information of other parties registered in the instant messenger;
select one of the displayed information of other parties; and
output a conversation window for having a conversation with the selected another party.

17. The method of claim 16, wherein displaying information of other parties registered in the instant messenger comprises visually distinguishably displaying information of at least one another party having transmitted a conversation message and information of the others.

18. The apparatus of claim 17, wherein displaying information of other parties registered in the instant messenger further comprises displaying information of at least one another party while being connected to the instant messenger.

19. The apparatus of claim 15, wherein the processor is further configured to:
activate a group selection menu using the selection window;
output, when the group selection menu is activated, a plurality of group names registered in the instant messenger;
select a specific group name from the plurality of group names; and
output the selected specific group name and information of parties included in the specific group.

20. The apparatus of claim 15, wherein the processor is further configured to:
activate the messenger selection menu using the selection window;
output, when the messenger selection menu is activated, indexes corresponding to a plurality of instant messengers provided by the mobile terminal;
select one of the plurality of indexes; and
output a user interface screen of an instant messenger corresponding to the selected index.
